(19) United States
(12) Patent Application Publication
(10) Pub. No.: US 2025/0307345 A1
(43) Pub. Date: Oct. 2, 2025

(54) Integrated Heterogeneous Processing Cores for Unified Independent Computation Execution

(71) Applicant: Tenstorrent USA, Inc., Austin, TX (US)

(72) Inventors: Kevin Greig, Toronto (CA); Ivan Matosevic, Toronto (CA)

(21) Appl. No.: 19/039,598

(22) Filed: Jan. 28, 2025

Related U.S. Application Data
(60) Provisional application No. 63/572,258, filed on Mar. 30, 2024.

(51) Int. Cl. G06F 17/16; G06F 9/50

(52) U.S. Cl. CPC G06F 17/16; G06F 9/505

(57) ABSTRACT

Computational architectures for the acceleration of complex computations, such as artificial intelligence workloads, and more specifically to heterogeneous computational architectures for the unified execution of a complex computation, are disclosed herein. A disclosed system for executing a complex computation includes a set of computational nodes, a network that networks the set of computational nodes, a set of accelerator computational nodes in the set of computational nodes that each include dedicated circuitry to accelerate operations in the complex computation, a set of additional computational nodes in the set of computational nodes that do not include the dedicated circuitry, and a set of instructions loaded into the set of computational nodes that, when executed by both the set of accelerator computational nodes and the set of additional computational nodes, cause the set of computational nodes to conduct a unified execution of the complex computation.

### CROSS REFERENCE TO RELATED APPLICATIONS

This application claims the benefit of U.S. Provisional Patent Application No. 63/572,258, filed on Mar. 30, 2024, which is incorporated by reference herein in its entirety for all purposes.

### BACKGROUND

Accelerators are specialized hardware components designed to offload specific intensive computational tasks from general-purpose processors (CPUs) in modern computing architectures, improving efficiency, speed, and energy consumption. These accelerators, such as GPUs (Graphics Processing Units), TPUs (Tensor Processing Units), and NPUs (Neural Processing Units), are optimized for tasks that are common in specific complex computations such as graphics rendering, machine learning, and deep learning models. Accelerators free up the CPU to manage other essential tasks, enhancing overall system performance.

Artificial intelligence (AI) accelerators are optimized for matrix multiplications and convolutions that are common in machine learning applications. In applications like image recognition, natural language processing, and data analysis, AI accelerators enable faster inference and training times, which is critical for real-time or large-scale deployments. The integration of AI accelerators into modern architectures supports efficient execution of AI workloads in data centers, edge devices, and consumer electronics, where both high performance and power efficiency are essential. As a result, AI accelerators play a crucial role in enabling advanced machine learning applications that would be impractical on traditional CPUs alone.

In modern computing architectures, accelerators operate in a master-servant relationship with CPUs, where the CPU acts as the primary controller (the “master”) and the accelerator functions as a specialized processing unit (the “servant”) that executes specific tasks on demand. The CPU manages the overall workflow, delegating computationally intensive tasks to the accelerator while maintaining control over task scheduling, data flow, and resource allocation. This relationship allows the CPU to handle diverse system-level operations and coordinate high-level logic, while the accelerator focuses on executing dedicated computations with speed and efficiency. In practice, this means that the CPU oversees data preparation and memory management, passing only the necessary data to the accelerator. Once the accelerator completes its computations, the CPU retrieves the results, integrates them with the system's broader tasks, and handles any further processing or decision-making. This master-servant dynamic leverages the strengths of both components: the CPU's versatility and the accelerator's raw computational power, resulting in a balanced, high-performance system. However, the master-servant relationship between CPUs and accelerators can introduce delays and bottlenecks in some scenarios.

### SUMMARY

This disclosure relates to computational architectures for the acceleration of complex computations, such as artificial intelligence (AI) workloads, and more specifically to heterogeneous computational architectures for the unified execution of a complex computation. The heterogeneous computational architectures can include networked computational nodes with a subset of the nodes being optimized for the computational tasks most often conducted in those complex computations along with an additional subset of nodes that are not. For example, the heterogeneous computational architecture could be a set of processing cores that are networked together to form a multicore processor which includes a set of AI accelerator cores that have dedicated circuitry for the accelerated execution of operations that make up the bulk of an AI workload along with additional processing cores that are used to conduct additional operations that make up a smaller portion of the AI workload.

The heterogeneous computational architecture disclosed herein can conduct a unified execution of a complex computation without direction from a higher-level controller. As used herein, the term unified execution refers to an execution by a set of computational nodes in which there are no master-servant relationships among the set of computational nodes and in which each computational node executes instructions to complete the complex computation and deliver a result of the complex computation in combination. Using the approaches disclosed herein, the disclosed computational architectures can conduct unified executions of complex computations more efficiently than systems which do use master-servant relationships between workload accelerators and general-purpose CPUs.

In traditional systems, while the master-servant relationship between CPUs and AI accelerators enables efficient handling of large, specialized computations, it can introduce delays in scenarios where tasks are discrete and interdependent or require frequent communication between the two units. When the accelerator is not optimized for handling discrete and fragmented portions of a complex computation, it will often have to wait for guidance or data from the CPU before proceeding, creating bottlenecks. In cases where small computations are continually interspersed with larger tasks, the CPU's role as a controller becomes a limiting factor, as each interaction introduces latency. This back-and-forth can prevent the overall architecture from fully utilizing its potential, reducing the performance benefits of offloading tasks in the first place.

In specific embodiments of the invention, the approaches disclosed herein include heterogeneous computing architectures that alleviate the problems mentioned above with respect to traditional systems. In these approaches, a set of computational nodes can conduct a unified execution of a complex computation where a subset of the computational nodes are designed to accelerate the bulk of the tasks involved in the complex computation and an additional subset of computational nodes is designed to accelerate additional tasks involved in the complex computation. The computational nodes that are designed to accelerate the bulk of the tasks can be referred to as accelerator computational nodes. The expected breakdown of frequency in specific tasks for a given complex computation delivered to the computing architecture for execution will impact the number of accelerator computational nodes and additional computational nodes in the set of computational nodes. For example, a complex computation that was expected to involve a large number of matrix multiplication and occasional external data look up operations could warrant the design of a heterogeneous computing architecture in the form of a multicore processor having 100 accelerator cores with matrix multiple units and 5 general purpose cores used for additional operations such as external data lookups and other math operations.

In specific embodiments of the invention, a set of computational nodes can execute a complex computation in a unified fashion by being programmed with instructions for the execution of the entire complex computation ex ante and then being left to execute the instructions that define the complex computation. Instead of a master-servant relationship, the set of computational nodes can asynchronously execute their assigned instructions and hold for responses or data from other computational nodes in the set when necessary. The set of computational nodes can share a common instruction set for the unified execution. While not all nodes in the set of computational nodes may be capable of executing every instruction, a compiler programmed with knowledge of which computational nodes can execute which operations can use the common instruction set to define the instructions needed for the entire unified execution of the complex computation. These approaches alleviate the latency introduced by the translations and asynchronous actions of the master and servant relationship in more traditional systems.

In specific embodiments of the invention, a set of computational nodes can execute a complex computation in a unified fashion by being networked together in a network used to exchange information between the computational nodes. The network can be a mesh network. The mesh network can include an extendible addressing scheme such as a scheme based on row and column addresses. The network can include a shared memory addressing scheme used to exchange data between the computational nodes. In alternative embodiments, the instructions that encode the complex computation for execution by the set of computational nodes can include data routing instructions for controlling the exchange of data amongst the computational nodes without reference to any shared memory addressing scheme. In specific embodiments, the network can also be used to load the instructions mentioned in the prior paragraph into the set of computational nodes. In specific embodiments, the mesh network can be a network on chip (NoC).

In specific embodiments, a system for executing a complex computation is provided. The system comprises a set of processing cores, a network-on-chip that networks the set of processing cores, a set of artificial intelligence accelerator cores in the set of processing cores that each include dedicated circuitry to accelerate matrix multiplication operations, a set of additional processing cores in the set of processing cores that do not include the dedicated circuitry to accelerate matrix multiplication operations, and a set of instructions loaded into the set of processing cores that, when executed by both the set of artificial intelligence accelerator cores and the set of additional processor cores, cause the set of processing cores to conduct a unified execution of the complex computation.

In specific embodiments, a method for executing a complex computation is provided. The method comprises loading a set of instructions into a set of processing cores using a network-on-chip that networks the set of processing cores, conducting a unified execution of the complex computation using the set of processing cores, and accelerating, during the unified execution, matrix multiplications in the set of instructions using a set of artificial intelligence accelerator cores in the set of processing cores. The set of artificial intelligence accelerator cores includes dedicated circuitry to accelerate matrix multiplication operations. The method also comprises executing, during the unified execution, additional instructions from the set of instructions using a set of additional processor cores in the set of processing cores. The additional processor cores do not include the dedicated circuitry to accelerate matrix multiplication operations.

In specific embodiments, a method for executing a complex computation is provided. The method comprises compiling a set of instructions for a set of processing cores to execute the complex computation. The compiling is done with reference to a common instruction set for the set of processing cores. The method also comprises loading the set of instructions into the set of processing cores using a network-on-chip that networks the set of processing cores, conducting a unified execution of the complex computation using the set of processing cores, and accelerating, during the unified execution, instructions in the set of instructions using a set of artificial intelligence accelerator cores in the set of processing cores. The set of artificial intelligence accelerator cores are not capable of executing a subset of the instructions in the common instruction set.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a system for executing a complex computation in accordance with specific embodiments of the inventions disclosed herein.

FIG. 2 provides an example of components of an AI accelerator processor core and components of an additional processing core in accordance with specific embodiments of the inventions disclosed herein.

FIG. 3 provides an example of a network executing a complex computation using AI processing cores and additional processing cores in accordance with specific embodiments of the inventions disclosed herein.

FIG. 4 provides an example of an additional processing core accessing information using an Ethernet portal in accordance with specific embodiments of the inventions disclosed herein.

FIG. 5 provides a method for executing a complex computation where AI accelerator cores include dedicated circuitry to accelerate matrix multiplication operations in accordance with specific embodiments of the inventions disclosed herein.

FIG. 6 provides a method for executing a complex computation where the set of AI accelerator cores are not capable of executing a subset of the instructions in accordance with specific embodiments of the inventions disclosed herein.

FIG. 7 shows examples of networks of processing cores with additional processing cores interspersed among AI accelerator cores in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for the acceleration of machine intelligence workloads or directed graphs in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to computational architectures for the acceleration of complex computations, such as AI workloads, and more specifically to heterogeneous computational architectures for the unified execution of a complex computation are disclosed herein. In specific embodiments, the computational nodes can be processing cores in a multicore processor. The computational nodes can be tensor processing units, matrix multiply units, artificial intelligence workload accelerators, or any kind of specialized processor for efficiently executing the computations required to either train or draw an inference from an artificial neural network. In specific embodiments, the computational nodes can be heterogeneous and include computational nodes of different types. For example, the computational nodes could include a set of computational nodes that are designed for general purpose computation and another set of nodes that are optimized for specific operations such as matrix multiplications or multiply accumulate (MAC) operations.

As used herein, the term artificial intelligence workload accelerator or (AI accelerator) will refer to specific computational nodes that have been designed specifically to perform common tasks conducted in the execution of an artificial intelligence workload such as matrix multiplications or MAC operations, while the term general purposes processor will refer to specific computational nodes that are more general purpose in terms of the workloads they are designed to process than AI accelerators.

The computational nodes in the networks of computational nodes disclosed herein can be networked together using a proprietary protocol. For example, a proprietary network on chip (NoC) protocol can be used to network the network of computational nodes. The network could be connected to the outside world using one or more external connections such as a PCIe bus or some other interface for connecting computers with peripherals. As such, workloads could be transferred into the network using such an external connection, the workload could be conducted by the network of computational nodes using the proprietary protocol to exchange data, and the result of the workload could then be transferred out of the network using the external connection.

In specific embodiments of the invention that are in accordance with the previous paragraphs, a network of computational nodes can include a set of heterogeneous computational nodes which are all networked together using a proprietary protocol. The computational nodes in such a network can be referred to as being fused because they share the same protocol for off-node communication and because they are networked together using a network that utilizes that protocol. In specific embodiments of the invention, the computational nodes in the set of heterogeneous computational nodes can also share the same L2 cache, higher level cache, or main memory. As an example, the computational nodes could include nodes that are specialized for specific linear computations and nodes that are capable of executing nonlinear computations. As another example, the computational nodes could include nodes that are specialized for matrix multiplications and nodes that are capable of executing geometric and trigonometric functions that are common for machine intelligence workloads such as those used for activation functions (e.g., Sigmoid operations, hyperbolic tangent functions, etc.).

In specific embodiments, the network of computational nodes can include nodes that are specialized for a particular operation that are commonly conducted in machine intelligence applications such as matrix multiplications and MAC operations and more general-purpose processors. For example, the nodes can include matrix multiply accelerators and fully functional CPUs. The more general-purpose processors can be used for nonlinear operations or other operations that are not as commonly conducted in machine intelligence applications. The more general-purpose processors can be used for vectorized nonlinear operations. As such, the network of computational nodes may be more easily adapted to new machine intelligence workloads that introduce new requirements in terms of the range of operations that must be executed for the workload to be completed.

In specific embodiments, the network of computational nodes can include nodes that can conduct complex data look up operations or that can conduct complex data look up operations more efficiently than the AI accelerators with which they are networked. These nodes can be general purpose processor cores. The data look up operations can involve an access to an external source such as through a PCIe connection or through an Ethernet connection. The nodes that are utilized for complex data look up operations can receive requests for the data from other nodes on the network and can generate a request for the external system and administrate the transfer of data from the external system back to the other nodes on the network.

In specific embodiments, a heterogeneous network of computational nodes with both AI accelerators and more general purpose processors will be able to execute more workloads without the necessity of producing a request for execution of a task off of the network, conducting a handshake with an external system, transmitting that request to the external system, and then translating the result back into a format that the network can operate on.

In specific embodiments of the invention, the composition of the network of computational nodes can be selected based on the expected workloads that the network will need to operate on. In specific embodiments, the ratio of AI accelerators to general purpose processors can be greater than 25 to 1. For example, a network of computational nodes could be a multicore processor with 4 general purpose CPU cores and 140 AI accelerators cores all networked together using a single NoC. Standard machine intelligence workloads can be executed efficiently using a network of computational nodes exhibiting such ratios. Accordingly, it is apparent why it is beneficial to have a set number of more generalized cores instead of enabling all the AI accelerator cores to be able to conduct the operations saved for the generalized cores (e.g., control-flow heavy tasks like data-base lookups). If each AI accelerator core was given the ability to conduct these operations it would lead to a major decrease in resource utilization as most of the cores would not, at any given time, be using the portion of the core used for those operations.

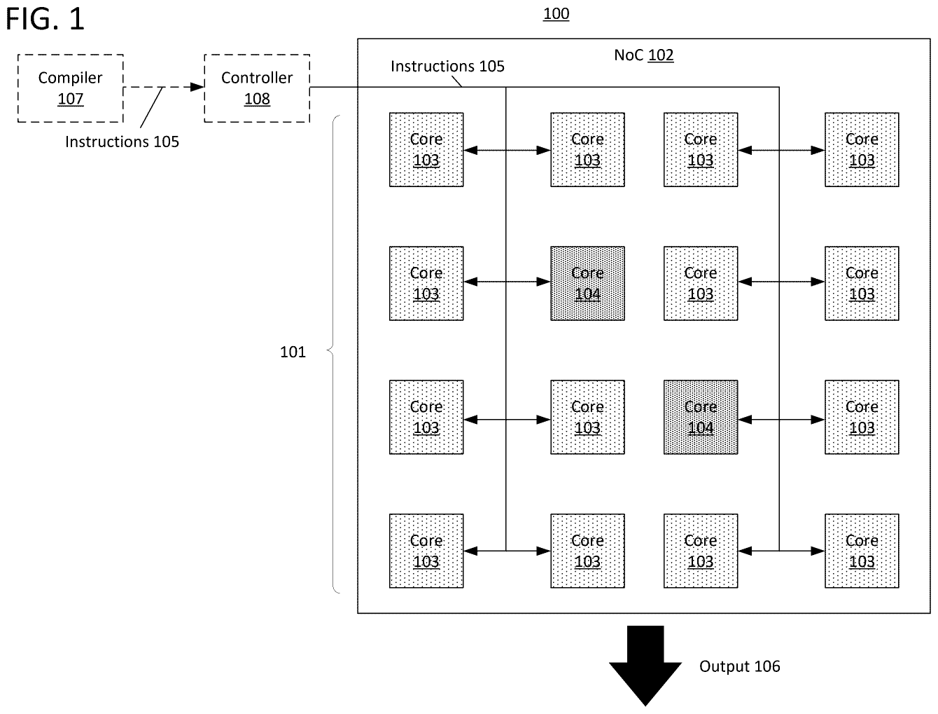

FIG. 1 provides an example of system 100 for executing a complex computation in accordance with specific embodiments of the inventions disclosed herein. System 100 includes set of processing cores 101, NoC 102, and a set of instructions 105. Set of processing cores 101 includes a set of AI accelerator cores 103 and a set of additional processing cores 104. The result of the complex computation may be part of output 106. An AI accelerator core may be a type of processing core. A processing core may also be referred to as a processor core and is another example of a computational node. Although sixteen processing cores 101 are shown, with fourteen AI accelerator cores 103 and two additional processing cores 104, system 100 may include any number of processing cores 101 with any ratio of AI accelerator cores 103 and additional processing cores 104. For example, in specific embodiments, AI accelerator cores 103 and additional processing cores 104 may be in a twenty-five to one ratio, or in a higher ratio. Processing cores 101 may collectively be a servant to another component such as controller 108, but neither AI accelerator cores 103 nor additional processing cores 104 are servants to each other. Executing set of instructions 105 may include moving data between cores 101 (e.g. between AI accelerator cores 103, between additional processing cores 104, and between AI accelerator cores 103 and additional processing cores 104). System 100 may include integrated heterogeneous processing cores (e.g., AI accelerator core 103 and additional processing cores 104) for unified independent computation execution.

System 100 may execute a complex computation. A complex computation may require a significant amount of processing power, memory, or sophisticated algorithms and have intricate calculations, large datasets, or numerous dependencies. Complex computations may be used in machine learning, deep learning, cryptography, scientific simulations, 3D graphics, data analysis, optimization problems, financial modeling, etc. Examples of complex computations may include computations related to the execution of a directed graph, the generation of an inference from a neural network, the production of a decoding from a transformer, and executing a cryptographic algorithm. For example, executing a cryptographic algorithm can include singing, verifying, hashing, key generation, key exchange, authentication, encryption, or decryption. System 100 may have specialized hardware for performing complex computations such as GPUs, TPUs, clusters of CPUs, etc.

The NoC 102 may network (e.g., interconnect) the set of processing cores 101. NoC 102 may allow processing cores 101 to collaborate through efficient communication mechanisms. Coordinated data sharing and synchronization mechanisms may be implemented to ensure that intermediate results are exchanged seamlessly, enabling the collective execution of complex computations. This collaborative approach may optimize the utilization of available computational resources, enhance parallelism, and contribute to the overall acceleration of workloads.

Some processing cores 101 in NoC 102 may include network layer circuitry such as a network interface unit (NIU). In specific embodiments, AI accelerator cores 103 include NIUs. In specific embodiments, additional processing cores 104 also include NIUs. In specific embodiments, additional processing cores 104 may include network interface units (NICs). The NIUs may serve as part of the network layer of NoC 102 and allow for communication between processing cores 101. The NIUs can control routers on each processing core 101 and packetize information for transmission through NoC 102. Each processing core 101 may also include one or more local memories. A memory can serve as the working memory for processing core 101 and store data and/or instructions which will be used by processing core 101. The memory can be an SRAM or any type of random-access memory. The memory can be a volatile or nonvolatile memory. NoC 102 may have a clocking or synchronous mechanism.

Although FIG. 1 shows a network of processing cores in a NoC, approaches disclosed herein are broadly applicable to any interconnect fabric which interconnects a set of computational nodes. Processing cores 101 may be implemented on a single chip system, in a multichip single package system, or in a multichip system in which the chips are commonly attached to a common substrate such as a printed circuit board (PCB), interposer, or silicon mesh. Any of these network implementations can be implemented using a variety of chip architectures, such as chiplets. The processing cores and interconnect fabric (e.g., the system that connects the processing cores) do not have to be on the same silicon substrate. Interconnect fabrics in accordance with this disclosure can also include chips on multiple substrates linked together by a higher-level common substrate such as in the case of multiple PCBs each with a set of chips where the multiple PCBs are fixed to a common backplane.

NoC 102 may use an extensible addressing scheme. Set of instructions 105 may use the extensible addressing scheme. An extensible addressing scheme may be an addressing scheme that can be extended or modified as a network grows or as new requirements arise. The extensible addressing scheme may allow for the addition of new fields or protocols without disrupting existing configurations. An extensible addressing scheme in a NoC protocol may be a way to identify processing cores 101 that is easy to scale as more processing cores 101 are added to system 100. An example of an extensible addressing scheme is an addressing scheme based on an x-y coordinate system. Each processing core 101 may be placed in a grid and assigned an (x,y) coordinate. To add more processing cores 101 to system 100, more rows (y) and/or columns (x) may be added to the address scheme (e.g. the address space may be extended without changing the basic addressing scheme). In specific embodiments, NoC 102 may include a shared memory addressing scheme used to exchange data between processing cores 101. In alternative embodiments, set of instructions 105 that encode the complex computation for execution by processing cores 101 can include data routing instructions for controlling the exchange of data amongst processing cores 101 without reference to any shared memory addressing scheme.

In specific embodiments, compiler 107 may generate set of instructions 105 for system 100. Compiler 107 may generate set of instructions 105 through a multi-step process that transforms high-level programming code into low-level machine code (or an intermediate representation). Compiler 107 may, for example, perform tokenization, parsing, semantic analysis, intermediate code generation, optimization, target code generation, assembly, and linking. Set of processing cores 101 includes two types of processing cores: AI accelerator cores 103 and additional processing cores 104. AI accelerator cores 103 and additional processing cores 104 are not interchangeable, as AI accelerator cores 103 may be unable to execute certain instructions and additional processing cores 104 may be unable to execute certain other instructions. Accordingly, compiler 107 may be programmed with knowledge of which computational nodes can execute which operations can use set of instructions 105 to define the instructions needed for the entire unified execution of the complex computation.

In specific embodiments, controller 108 may load set of instructions 105 into the set of processing cores 101 using NoC 102. Controller 108 may load set of instruction 105 onto processing cores 101 by transferring data over NoC 102. Transferring data may include distributing instructions efficiently, managing communication protocols, and ensuring synchronization across NoC 102. Set of instructions 105 may be preloaded into memory that controller 108 or processing cores 101 can access. NoC 102 may use specific routing algorithms (e.g., XY routing or adaptive routing) to direct data (e.g., data packets from set of instructions 105). In specific embodiments, processing cores 101 may route set of instructions 105 to other processing cores 101.

In specific embodiments, all processing cores 101 are loaded with instructions from set of instructions 105 at the same time. In specific embodiments, all processing cores 101 are loaded with instructions from set of instructions 105 prior to the executions of any of the instructions. In specific embodiments, all processing cores 101 are loaded with the entire set of instructions 105 (e.g., each processing core 101 may receive each instruction of set of instructions 105). In specific embodiments, the same set of instructions may be loaded on multiple processing cores 101 (e.g., AI accelerator cores 103 and additional processing cores 104). NoC 102 may support multicast or broadcast modes to send set of instructions 105 to several processing cores 101 in a single transmission. In specific embodiments, NoC 102 can load different instructions from set of instructions 105 on multiple processing cores 101 simultaneously by sending packets to the coordinates of each target processing core 101.

Set of processing cores 101 may execute set of instructions 105 with a unified execution (e.g., execute a unified independent computation). The unified execution may be unified in that there are no master-servant relationships among the set of processing cores 101 and each of the processing cores 101 may operate as peers or equals without a single core exerting control over the others (e.g., a decentralized or distributed architecture). Each processing core 101 may have an equal role and may not depend on another processing core 101 for instructions or management. That is, processing cores 101 may work independently or cooperatively without one processing core 101 dictating the tasks of the other processing cores 101. Processing cores 101 may make independent decisions or follow their own control logic, allowing them to operate autonomously or collaboratively through a shared protocol or consensus mechanism. Executing set of instructions 105 may include moving data between processing cores 101 (e.g., between AI accelerator cores 103, between additional processing cores 104, and between AI accelerator cores 103 and additional processing cores 104). Processing cores 101 may communicate directly with each other over NoC 102 (e.g., or another communication fabric) rather than through a centralized master core. Processing cores 101 may exchange data or synchronize without a central coordinator. Instead of a master-servant relationship, the set of processing cores 101 can asynchronously execute their assigned instructions and hold for responses or data from other processing cores 101 when necessary. The set of processing cores 101 can share a common instruction set (e.g., set of instructions 105) for the unified execution. That is, in specific embodiments, all instructions of set of instructions 105 may be sent to all processing cores 101, including AI accelerator cores 103 and additional processing cores 104. Set of instructions 105 may be common or accessible to both types of processing cores 101.

Set of instructions 105 may be distributed among processing cores 101 dynamically. For example, processing cores 101 may pull tasks from a shared task queue or use a load-balancing mechanism to distribute work evenly. AI accelerator cores 103 and additional processing cores 104, within the set of processing cores 101, may be specialized for different tasks and pull the tasks from the shared task queue accordingly. In specific embodiments, processing cores 101 may use peer-to-peer cache coherency protocols to keep data consistent across processing cores 101.

Each of the processing cores 101 may execute instructions in the set of instructions 105 to complete the complex computation. Set of instructions 105 may be distributed across processing cores 101 such that each processing core 101 is responsible for part of the set of instructions 105. Processing cores 101 may share information or intermediate results directly with other processing cores 101. Set of instructions 105 may be from a common instruction set for system 100. That is, the set of processing cores 101 can share a common instruction set for the unified execution of the complex computation.

In specific embodiments, dedicated circuitry of AI accelerator core 103 may accelerate common tasks associated with machine learning application such as matrix multiplications, pooling operations, convolutions, graphics rendering, machine learning, deep learning, non-linear operations for machine learning layer activations, etc. The dedicated circuitry may be more specialized than an arithmetic logic units (ALU) or a floating-point unit (FPU). For example, the dedicated circuitry may be or include a multiplier-accumulator unit (MAC unit), convolution engine, dataflow engine, neural processing unit (NPU), tensor processing unit (TPU), matrix multiplication unit (MMU), activation function unit, vector processing unit (VPU), sparsity exploitation unit, weight storage and decompression unit, fine-grained parallelism unit, energy-efficient processing block, quantization support unit, etc. The dedicated circuitry may include or use a systolic array, specialized memory hierarchy, high-bandwidth memory (HBM) interface, optimized dataflow architecture, neuromorphic circuitry, etc. The dedicated circuitry may use or process a rectifier linear unit (ReLU), exponential linear unit (ELU), scaled exponential linear unit (SELU), Gaussian error linear unit (GELU), Sigmoid function, hyperbolic function (e.g., Tanh), softplus function, swish activation function, switch activation function, etc. The dedicated circuitry may include a combination of specialized features and architectures including multiples of a feature or variations of a feature. The dedicated circuitry may be specifically configured to accelerate matrix multiplications.

The set of additional processing cores 104 may be a set of general-purpose processor cores. In specific embodiments, additional processing cores 104 may refer to processing cores that are not AI accelerator cores 103. Additional processing cores 104 may be processor cores that can instantiate an operating system. Additional processing cores 104 may be processing cores that can look up data external to system 100 and can translate the data into a common protocol (e.g., language) of NoC 102. In specific embodiments, none of the additional processing cores 104 in the set of processing cores 101 include dedicated circuitry to accelerate matrix multiplication operations. That is, dedicated circuitry for accelerating matrix multiplications may be absent from additional processing cores 104.

The set of AI accelerator cores 103 may not be capable of executing a subset of the instructions in set of instructions 105. This subset of instructions may be executed by additional processing cores 104. AI accelerator cores 103 may have dedicated circuitry for the accelerated execution of operations that make up the bulk of set of instruction 105 while additional processing cores 104 are used to conduct additional operations that make up a smaller portion of set of instructions 105. The set of AI accelerator cores 103 may not be capable of executing this smaller portion of set of instructions 105.

AI accelerator cores 103 and additional processing cores 104 may execute different types of instructions within set of instructions 105. Corresponding differences in hardware between AI accelerator cores 103 and additional processing cores 104 may provide for the specialization of these types of processing cores within the set of processing cores 101. Additional processing cores 104 may include hardware that is absent or reduced in AI accelerator cores 103. In specific embodiments, this hardware may execute the subset of instructions that AI accelerator cores 103 are incapable of (or non-optimized for) executing. For example, AI accelerator cores 103 may not have, or may have minimized versions of, complex control logic, instruction decoders, floating-point units (FPUs), arithmetic logic units (ALUs), branch prediction units, out-of-order execution units, cache coherency logic, interrupt handling, exception management units, register files, etc. Additional processing cores 104 may include these hardware components and may use them to perform functions such as conditional branching, interrupts, exceptions, operating system-level commands, cache coherency, instruction-level parallelism (ILP), multi-threading, etc. AI accelerator cores 103 may have different hardware than additional processing cores 104. For example, AI accelerator cores 103 may use streamlined control logic (as AI accelerator cores 103 may focus on repetitive operations with less need for diverse instructions), may prioritize continuous, uninterrupted processing (rather than system-level exceptions or asynchronous events), and may prioritize data-level-parallelism (DLP) over ILP (because AI tasks typically process large datasets in parallel).

In specific embodiments, additional processing cores 104 may conduct complex data look up operations more efficiently than the AI accelerator cores 103. Additional processing cores 104 can be general purpose processors. The data look up operations can involve an access to an external source such as through a PCIe connection or through an Ethernet connection. Additional processing cores 104 can receive requests for data from other processing cores 101 on NoC 102, can generate a request for the external system, and can administrate the transfer of data from the external system back to the other processing cores 101 on NoC 102.

One or more additional processing cores 104 may be capable of instantiating an operating system (e.g., Linux). One or more additional processing cores 104 may load, initialize, and begin running an operating system on a computing system. The operating system may then manage system resources and provide services to applications and user interactions. Additional processing cores 104 may run, or initiate other hardware to run, processes such as executing firmware instructions, loading a bootloader, transferring control to the operating system kernel, setting up core services, enabling multicore support, starting user-level processes, and starting user-level interfaces. In specific embodiments, the operating system is Linux compatible.

In specific embodiments, set of instructions 105 may include instructions for an additional processing core 104 to access information for a complex computation using an Ethernet portal. Additional processing core 104 may communicate with external devices or systems over an Ethernet network. Additional processing core 104 may use a network interface controller (NIC) and the transmission control protocol/internet protocol (TCP/IP) protocol stack. The NIC may act as a bridge between additional processing core 104 and the Ethernet network. Additional processing core 104 may construct a request (e.g., HTTP request, database query, file transfer command, etc.) and may pass this request through a series of software layers that package the request into a format for network transmission (e.g., using the TCP/IP stack). The NIC may translate the Ethernet frame into an electrical or optical signal and may send the signal over an Ethernet cable. When data is sent back into additional processing core 104 from an external device, the data may be in an Ethernet frame format. Additional processing core 104 (e.g., the NIC) may convert the Ethernet frames into digital packets and send the packets up the network stack of the operating system of system 100. In specific embodiments, the NIC may use direct memory access (DMA). Additional processing core 104 may deliver the data to one or more AI accelerator cores 103 and/or one or more different additional processing cores 104.

Set of instructions 105 may be loaded into the set of processing cores 101. When executed by both the set of AI accelerator cores 103 and the set of additional processing cores 104, the set of instructions 105 may cause the set of processing cores 101 to conduct a unified execution of the complex computation. Output 106 may include the result of the complex computation. The heterogeneous processing core architecture (e.g., AI accelerator cores 103 and additional processing cores 104) may reduce delays in scenarios where tasks are discrete and interdependent. As the complex computation has a unified execution (e.g., no master-servant relationship between processing cores 101), AI accelerator cores 103 may not have to wait for guidance or data from a CPU concerning discrete and fragmented portions of the complex computation. Instead, additional processing cores 104 may handle the discrete and fragmented portions (e.g., small computations, external data look up) of the complex computation.

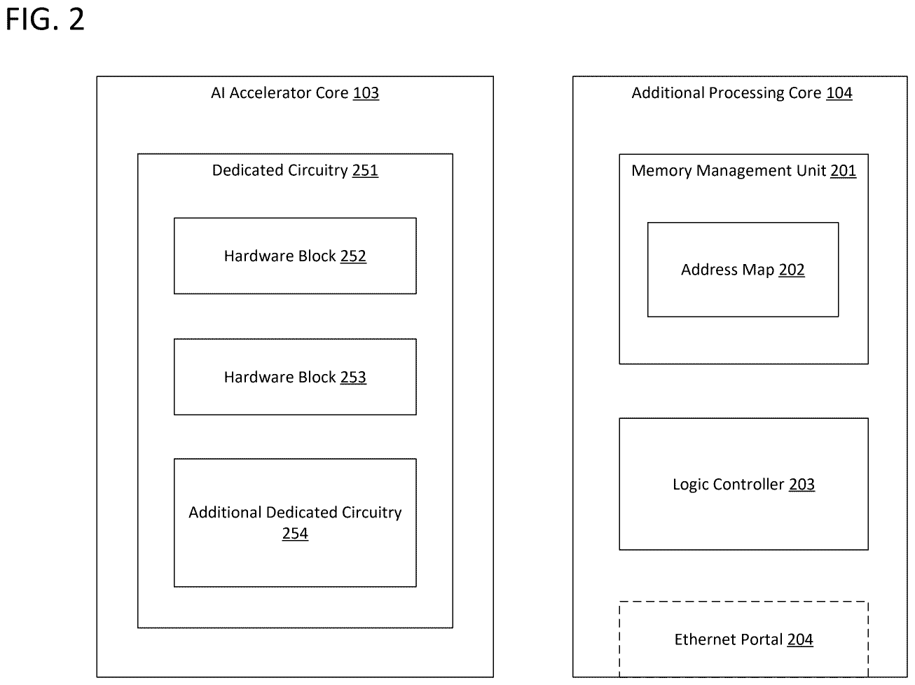

FIG. 2 provides an example of components of additional processing core 104 and components of AI accelerator core 103 in accordance with specific embodiments of the inventions disclosed herein. Additional processing core 104 may be a general-purpose processor core. Additional processing core 104 may be representative of the set of additional processing cores 104 in FIG. 1. AI accelerator core 103 may be representative of AI accelerator cores 103 in FIG. 1. Additional processing core 104 and AI accelerator core 103 may be part of a peer network and may both receive the same set of instructions. A subset (e.g., a small portion) of instructions of a set of instructions may be more efficiently executed by additional processing core 104 than by AI accelerator core 103. For example, AI accelerator core 103 may not have the hardware required to execute, or optimized to execute, the subset of instructions. A second subset of instructions (e.g., a large portion) of instructions of the set of instructions may be more efficiently executed by AI accelerator core 103 than by additional processing core 104. For example, additional processing core 104 may not have hardware required to execute, or optimized to execute, the second subset of instructions.

Additional processing core 104 may include memory management unit 201, address map 202, and logic controller 203. Address map 202 may be operating system specified. Logic controller 203 may be programmable. In specific embodiments, additional processing core 104 may include Ethernet portal 204. Some circuitry (e.g., dedicated circuitry 251) that is present in AI accelerator core 103 may be absent from (or modified for) additional processing core 104. For example, additional processing cores 104 may not have dedicated circuitry to accelerate matrix multiplication operations. Additional processing core 104 may be a general-purpose processor core. In specific embodiments, additional processing core 104 may refer to a processing core that is not an AI accelerator core 103. Additional processing core 104 may be a processor core that can instantiate an operating system. Additional processing core 104 may be a processing core that can look up data external the system and can translate the data into a common protocol (e.g., language) of the network of processing cores.

Memory management unit 201 may act as a bridge between physical memory and a central processing unit of additional processing core 104. For example, memory management unit 201 may manage mapping between virtual addresses and physical addresses, allowing additional processing core 104 to support virtual memory, memory protection, and efficient memory access. Memory management unit 201 may perform features such as address translation, memory protection, virtual memory management, efficient access with a translation lookaside buffer (TLB), segmentation, paging, and process isolation. Memory management unit 201 may include address map 202. Memory management unit 201 may be absent from, or modified for, AI accelerator core 103. AI accelerator core 103 may be specialized for matrix multiplication and may not be capable of, or optimized for, accessing memory (e.g., external memory).

Address map 202 may be a structured layout that defines how different memory addresses correspond to various components, memory regions, and input/output (I/O) devices with a system. Address map 202 may also be referred to as page tables or segment tables. In specific embodiments, address map 202 may include addresses for external devices connected with additional processing core 104 via Ethernet portal 204. Mapping may assist additional processing core 104 in locating specific data or devices in the address space and in accessing these resources efficiently. Address map 202 may divide the addressable space of additional processing core 104 into specific regions for various types of memory such as random access memory (RAM), read-only memory (ROM), cache, etc. Address map 202 may include specific ranges that correspond to hardware devices (e.g., BPUs, NICs, storage controllers). Some address regions of address map 202 may be marked as shared between processing cores. Address map 202 may also define access permissions for different memory areas. Address map 202 may use physical memory addresses, virtual memory addresses, or a combination thereof. Address map 202 may allow additional processing core 104 to quickly locate and manage memory and devices, organize memory and device access, and facilitate communication. Address map 202 may be absent from, or modified for, AI accelerator core 103. AI accelerator core 103 may be specialized for matrix multiplication and may not be capable of, or optimized for, accessing memory (e.g., external memory).

Logic controller 203 may coordinate and manage the execution of instructions within additional processing core 104. For example, logic controller 203 may ensure that memory management unit 201, Ethernet portal 204, and other components of additional processing core 104 work together efficiently to execute instructions. In specific embodiments, logic controller 203 may perform instruction decoding, control signal generation, manage sequencing and timing, handle interrupts and exceptions, manage branching and jumps, and manage power and resources. Logic controller 203 may be absent from, or modified for, AI accelerator core 103. AI accelerator core 103 may be specialized for matrix multiplication and may not be capable of, or optimized for, executing a variety of instruction types. Logic controller 203 may perform functions in additional processing core 104 that are not performed in AI accelerator core 103. For example, logic controller 203 may identify the type of instruction (e.g., arithmetic, logical, memory access, or control flow) in additional processing core 104 while AI accelerator core 103 executes repetitive, matrix-heavy operations with less need for diverse instructions, such as matrix multiplication or activation functions.

In specific embodiments, additional processing cores 104 may conduct complex data look up operations more efficiently than an AI accelerator core (e.g., AI accelerator core 103). The data look up operations can involve an access to an external system such as through a PCIe connection or through an Ethernet connection. Additional processing core 104 may receive requests for data from other processing cores, from a controller, or from a compiler. Additional processing core 104 may generate a request for the external system (e.g., an external data source) and may administrate the transfer of data from the external system to the other processing cores.

Additional processing core 104 may instantiate an operating system. Additional processing core 104 may instantiate Ethernet portal 204 using the operating system. In specific embodiments, the operating system may be Linux compatible. Instantiating Ethernet portal 204 may allow additional processing core 104 to communicate with other devices over the Ethernet network. Additional processing core 104 may establish and initialize an Ethernet network interface for a system, such as system 100, enabling the system to communicate over an Ethernet network. As part of instantiating Ethernet portal 204, a NIC of additional processing core 104 may power on and initialize the NIC. The operating system may configure software components for network communication including setting up a network protocol stack (e.g., TCP/IP). Ethernet portal 204 may have an IP address that is statically or dynamically assigned. Additional processing core 104 may configure transmission parameters (e.g., link speed, duplex mode, maximum transmission unit (MTU), etc.). Additional processing core 104 may perform a basic connectivity test (e.g., ping request) to confirm that Ethernet portal 204 is fully instantiated and operational. Additional processing core 104 may also establish security protocols or configurations. Once Ethernet portal 204 is fully configured and the NIC is activated, additional processing core 104 may send and receive data packets over the Ethernet network.

Additional processing core 104 may include a variety of hardware. For example, additional processing core 104 may include a combination of complex control logic, instruction decoders, FPUs, ALUs, branch prediction units, out-of-order execution units, cache coherency logic, interrupt handling, exception management units, register files, etc. Additional processing core 104 may use hardware components to perform functions such as conditional branching, interrupts, exceptions, operating system-level commands, cache coherency, instruction-level parallelism (ILP), multi-threading, etc. These hardware components may be unique to additional processing core 104 (e.g., they may be absent or reduced in AI accelerator cores). For example, additional processing core 104 may include branch prediction units while AI accelerator core 103 does not, AI accelerator core 103 instead optimizing for parallelized execution of repetitive tasks with minimal branching. As another example, additional processing core 104 may include out-of-order execution units to enable additional processing core 104 to execute instructions non-sequentially while AI accelerator core 103 does not have an out-of-order execution unit but rather is optimized for in-order, predictable, and highly parallel data processing pipelines. Additional processing core 104 may include a multi-level cache (e.g., L1, L2, L3) to optimize data access across various types of workloads while AI accelerator core 103 may use scratchpad memory or a single, large, shared buffer for accessing large, structured data blocks.

AI accelerator core 103 may include dedicated circuitry 251. Dedicated circuitry 251 may include hardware block 252, hardware block 253, and additional dedicated circuitry 254. Hardware blocks 252 and 253 may accelerate matrix multiplications. AI accelerator core 103 may help execute a set of instructions. The set of instructions may be from a common instruction set for a system including AI accelerator core 103 and additional processing core 104. AI accelerator core 103 may not be capable of (e.g., may not include the hardware for) executing a subset of the instructions in the common instruction set.

Dedicated circuitry 251 of AI accelerator core 103 may accelerate tasks associated with machine learning application such as matrix multiplications, pooling operations, convolutions, graphics rendering, machine learning, deep learning, non-linear operations for machine learning layer activations, etc. Dedicated circuitry 251 may include hardware blocks 252 and 253. Although two hardware blocks 252 and 253 are shown, AI accelerator core 103 may include any number of hardware blocks. Hardware block 252 may include the same hardware as hardware block 253, may include different hardware, or may include portions of the same hardware and portions of different hardware. Hardware blocks 252 and 253 may be or include: a MAC unit, GPU, convolution engine, dataflow engine, NPU, TPU, MMU, activation function unit, VPU, DSP, NNA, sparsity exploitation unit, weight storage and decompression unit, fine-grained parallelism unit, energy-efficient processing block, quantization support unit, low-precision arithmetic units (e.g., FP16, INT8), non-volatile memory (NVM) for on-chip storage, etc. Dedicated circuitry 251 (e.g., hardware blocks 252 and 253) may include or use a systolic array, specialized memory hierarchy, high-bandwidth memory (HBM) interface, optimized dataflow architecture, neuromorphic circuitry, etc. Dedicated circuitry 251 (e.g., hardware blocks 252 and 253) may use or process a ReLU, ELU, SELU, GELU, Sigmoid function, hyperbolic function (e.g., Tanh), Softplus function, Swish activation function, Switch activation function, etc. Dedicated circuitry 251 (e.g., hardware blocks 252 and 253) may include a combination of specialized features and architectures including multiples of a feature or variations of a feature. Hardware blocks 252 and 253 may be specifically configured to accelerate matrix multiplications.

Additional dedicated circuitry 254 of AI accelerator core 103 may accelerate a non-linear operation. For example, additional dedicated circuitry 254 may accelerate at least one of the following non-linear operations: ReLU, ELU, SELU, Sigmoid, Tanh, Softplus, Swish, Switch, and GELU. To accelerate a non-linear operation, additional dedicated circuitry may be (or include) one or more: activation function units, lookup tables (LUTs), polynomial approximation hardware, sparce computation engines, exponential and logarithmic function units, piecewise linear approximation blocks, trigonometric function units, non-linear data transformation units, Softmax and normalization accelerators, non-linear filtering hardware, stochastic computing units, configurable logic blocks, etc. For example, an activation function unit of additional dedicated circuitry 254 may be designed to compute functions such as ReLU, ELU, SELU, GELU, Tanh, Sigmoid functions, Swish functions, Switch functions, Softplus functions, etc.

Additional processing core 104 and AI accelerator core 103 may be part of a peer network and may both receive the same set of instructions. AI accelerator core 103 and additional processing core 104 may execute different types of instructions within the set of instructions. AI accelerator core 103 and additional processing cores 104 may have different hardware that provides each core with specialized capabilities compared to the other. Additional processing core 104 may include hardware that is absent or reduced in AI accelerator cores 103, such as memory management unit 201, address map 202, logic controller 203, and Ethernet portal 204, which may execute a subset of instructions that AI accelerator core 103 may be incapable of (or non-optimized for) executing. Additional processing core 104 may use these hardware components to execute instructions related to conditional branching, interrupts, exceptions, operating system-level commands, cache coherency, instruction-level parallelism (ILP), multi-threading, etc. AI accelerator core 103 may include hardware that is absent or reduced in additional processing core 104, such as dedicated circuitry 251, hardware block 252, hardware block 253, and additional dedicated circuitry 254, which may execute a second subset of instructions that additional processing core 104 may be incapable of (or non-optimized for) executing. AI accelerator core 103 may use these hardware components to execute instructions related to matrix multiplication, vector operations, parallel processing, non-linear activation functions, sparce matrix operations, etc.

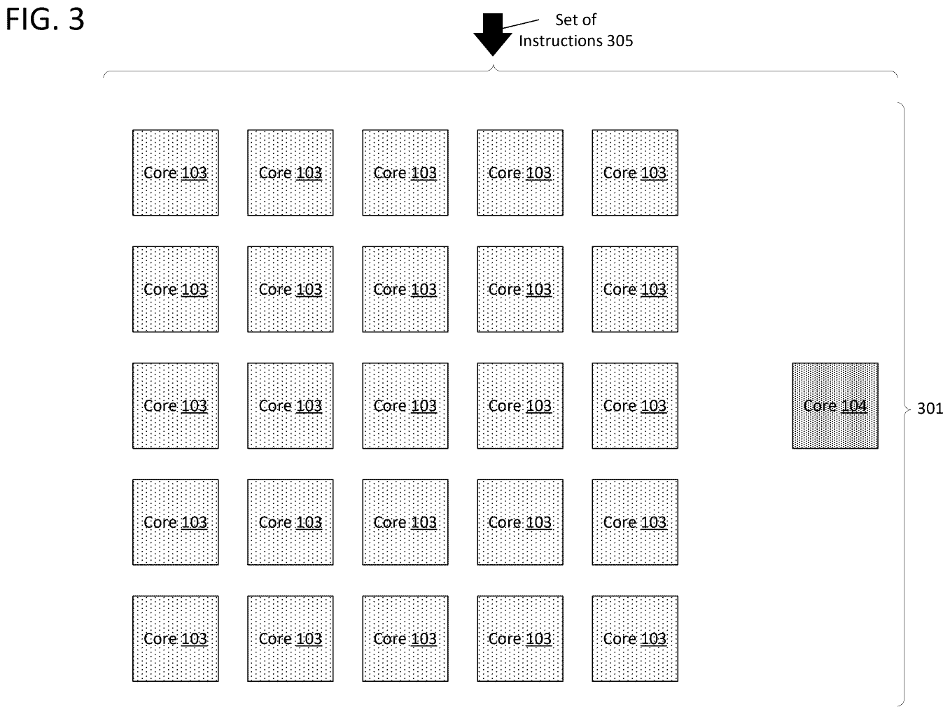

FIG. 3 provides an example of network 301 executing a complex computation with AI accelerator cores 103 and additional processing core 104 in a ratio of twenty five to one in accordance with specific embodiments of the inventions disclosed herein. Each core (AI accelerator cores 103 and additional processing core 104) in network 301 may be loaded with set of instructions 305. Each of the processing cores may execute instructions in set of instructions 305 to complete the complex computation (e.g., the execution of set of instructions 305 may be unified). There is no master-servant relationship between the cores of network 301. Network 301 may collectively be a servant to another component such as a controller, but neither AI accelerator cores 103 nor additional processing core 104 are servants to each other. Additional processing core 104 and AI accelerators cores 103 may all be networked together using a single NoC. Executing set of instructions 305 may include moving data between the cores (e.g. between different AI accelerator cores 103 and between AI accelerator cores 103 and additional processing cores 104).

Although FIG. 3 shows network 301 with AI accelerator cores 103 and additional processing core 104 in a ratio of twenty five to one, other ratios are possible (e.g., network 301 may have a ratio of at least twenty five to one). Any number of AI accelerator cores 103 and any number of additional processing cores 104 may be part of network 301. In specific embodiments of the invention, the composition of the network of processing cores may be selected based on the expected workloads that the network will operate on. Additionally, AI accelerator cores 103 and any number of additional processing cores 104 may be physically arranged in a variety of ways within network 301. For example, additional processing cores 104 may be interspersed among AI accelerator cores 103 or may be placed in a portion of an interconnected mesh (e.g., NoC) dedicated to additional processing cores. In specific embodiments, additional processing cores 104 may be placed among AI accelerator cores 103 such that the average physical distance from an AI accelerator core 103 to an additional processing core 104 is minimized. This may reduce communication latency, as latency may be a function of physical distance for on-die communication.

Network 301 may conduct a unified execution of a complex computation where AI accelerator cores 103 are designed to accelerate the bulk of the tasks involved in the complex computation and additional processing core 104 is designed to accelerate additional tasks involved in the complex computation. The specific ratio of AI accelerator cores 103 to additional processing cores 104 may be based on the type of program that network 301 is built to process. The expected breakdown of frequency in specific tasks for a given complex computation delivered to network 301 (e.g., the computing architecture) for execution will impact the number of (and ratio of) AI accelerator cores 103 and additional processing cores 104 in network 301. For example, a complex computation that was expected to involve a large number of matrix multiplication and occasional external data look up operations could warrant the design of a heterogeneous computing architecture in the form of a multicore processor having 25 AI accelerator cores 103 with matrix multiplication units and one additional processing core 104 (e.g., general purpose core) used for additional operations such as external data lookups and other math operations. In specific embodiments, the ratio of AI accelerator cores 103 to additional processing cores 104 can be greater than 25 to 1. In specific embodiments, a network may be built having 140 AI accelerator cores 103 with matrix multiplication units and 4 additional processing cores 104. Standard machine intelligence workloads can be executed efficiently using a network of computational nodes exhibiting these and other ratios.

AI accelerator cores 103 and additional processing cores 104 may execute different types of instructions within set of instructions 305. Corresponding differences in hardware between AI accelerator cores 103 and additional processing cores 104 may provide for the specialization of the processing cores. Additional processing core 104 may include hardware that is absent or reduced in AI accelerator cores 103. In specific embodiments, this hardware may execute a small portion of instructions that AI accelerator cores 103 are incapable of (or non-optimized for) executing. AI accelerator cores 103 may include hardware that is absent or reduced in additional processing core 104. This hardware may execute the bulk of set of instruction 305 that additional processing core 104 is incapable of (or non-optimized for) executing. As AI accelerator cores 103 may perform the bulk of set of instructions 305, there may be more AI accelerator cores 103 than additional processing cores 104 in network 301.

Having a set number of more generalized cores (e.g., additional processing cores 104) instead of enabling all AI accelerator cores 103 to be able to conduct the operations saved for the generalized cores (e.g., control-flow heavy tasks like data-base lookups) improves resource utilization. For example, if each AI accelerator core was given the ability to conduct these operations it would lead to a major decrease in resource utilization as most of the cores would not, at any given time, be using the portion of the core used for those operations. The heterogeneous processing core architecture may reduce delays in scenarios where tasks are discrete and interdependent. AI accelerator cores 103, which are not optimized for handling discrete and fragmented portions of a complex computation, may not have to wait for guidance or data from a CPU before proceeding. Instead, additional processing cores 104 may handle the discrete and fragmented portions (e.g., small computations, external data look up) of the complex computation.

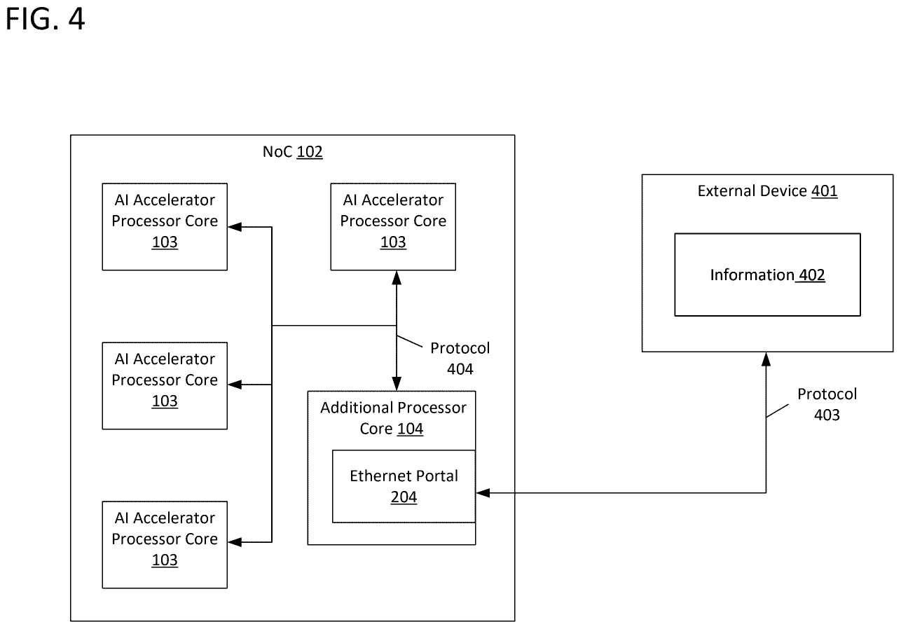

FIG. 4 may illustrate an example of additional processing core 104 accessing information 402 using Ethernet portal 204 to execute a complex computation in accordance with specific embodiments of the inventions disclosed herein. External device 401 may store information 402. Additional processing core 104 and AI accelerator cores 103 may execute the complex computation using a set of instructions. Each instruction of the set of instructions may be sent to each core of Noc 102. Components of NoC 102 (AI accelerator cores 103 and additional processing core 104) may communicate with each using a first protocol 404. Additional processing core 104 may communicate with external device 401 using a second protocol 403. Protocol 403 may be different than protocol 404. Protocol 404 may be a NoC protocol such as AXI, CHI, TileLink, CCIX, OpenPICC, PCIe, or a custom protocol. Protocol 403 may be Ethernet protocol or another protocol. Ethernet portal 204 may convert data packets from protocol 404 to protocol 403 or from protocol 403 to protocol 404. Additional processing core 104 may instantiate an operating system (e.g., Linux).

Additional processing core 104 may instantiate Ethernet portal 204 using an operating system. In specific embodiments, the operating system may be Linux compatible. Instantiating Ethernet portal 204 may allow processing core 104 to communicate with other devices over the Ethernet network. Processing core 104 may establish and initialize an Ethernet network interface for a system, such as system 100, enabling the system to communicate over an Ethernet network. As part of instantiating Ethernet portal 204, a NIC of processing core 104 may power on and initialize. The operating system may configure software components for network communication including setting up a network protocol stack (e.g., TCP/IP). Ethernet portal 204 may have an IP address that is statically or dynamically assigned. Processing core 104 may configure transmission parameters (e.g., link speed, duplex mode, maximum transmission unit (MTU), etc.). Processing core 104 may perform a basic connectivity test (e.g., ping request) to confirm that Ethernet portal 204 is fully instantiated and operational. Processing core 104 may also establish security protocols or configurations. Once Ethernet portal 204 is fully configured and the NIC is activated, processing core 104 may send and receive data packets over the Ethernet network.

Additional processing core 104 may access, using Ethernet portal 204, information 402 for the complex computation. Additional processing core 104 may access information 402 based on an instruction in the set of instructions loaded into the set of cores in NoC 102. In specific embodiments, the set of instructions for executing the complex computation may include instructions for additional processing core 104 to access information 402 using an Ethernet portal 204. External device 401 may store information 402. Additional processing core 104 may communicate with external device 401 over an Ethernet network such that protocol 403 is an Ethernet protocol. Additional processing core 104 may use a NIC and the TCP/IP protocol stack. The NIC may act as a bridge between additional processing core 104 and the Ethernet network. Additional processing core 104 may construct a request (e.g., HTTP request, database query, file transfer command, etc.) and may pass this request through a series of software layers that package the request into a format for network transmission (e.g., using the TCP/IP stack). The NIC may translate the Ethernet frame into an electrical or optical signal and may send the signal over an Ethernet cable. External device 401 may send information 402 to additional processing core 104 in an Ethernet frame format. The NIC may convert the Ethernet frames into digital packets and send the packets up the network stack of the operating system. In specific embodiments, the NIC may use direct memory access (DMA). Additional processing core 104 may deliver information 402 to one or more AI accelerator cores 103 and/or one or more different additional processing cores 104.

The heterogeneous processing core architecture may reduce latency compared to a homogeneous processing core architecture. Additional processing cores 104 may handle external data look up (e.g., via Ethernet portal 204) of a complex computation such that AI accelerator cores 103 do not have to wait for guidance or data from a CPU. AI accelerator cores 103 and additional processing cores 104 may operate as peers in a unified execution of a complex computation.

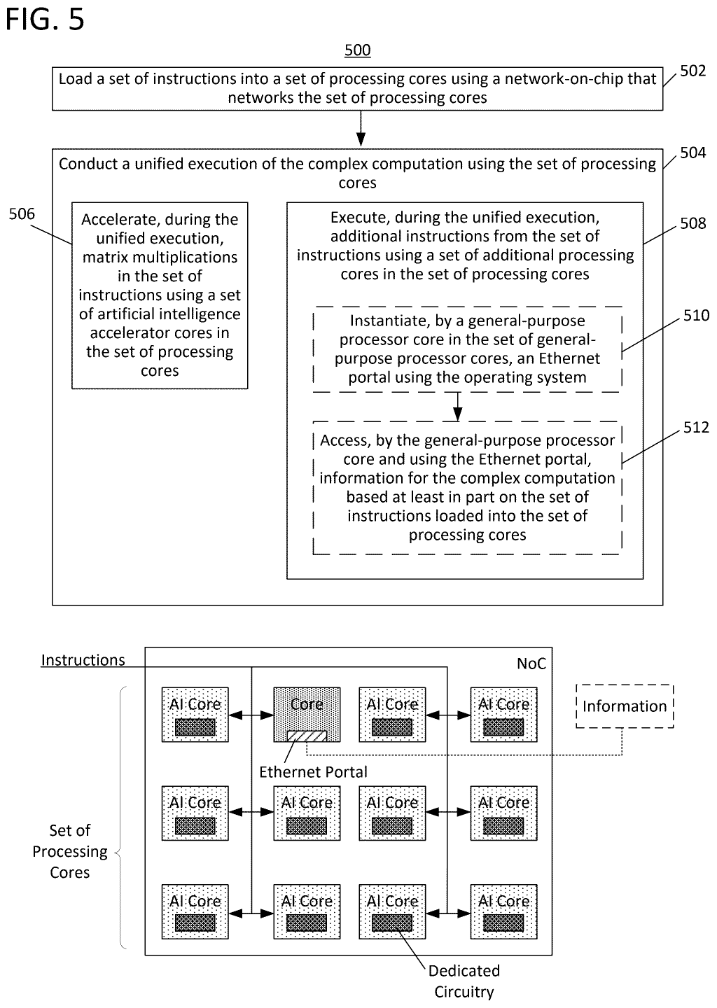

FIG. 5 shows method 500 for executing a complex computation where AI accelerator cores include dedicated circuitry to accelerate matrix multiplication operations in accordance with specific embodiments of the inventions disclosed herein. Method 500 may be performed by a system including a set of processing cores, a NoC, a set of AI accelerator cores, a set of additional processing cores, and a set of instructions. In specific embodiments, the system may also include a compiler and a controller. Steps, or portions of steps, of method 500 may be omitted, duplicated, rearranged or otherwise deviate from the form shown. Some steps of method 500 may occur simultaneously while others occur sequentially.

At step 502, a set of instructions may be loaded into a set of processing cores. The set of instructions may be loaded using a NoC that networks the set of processing cores.

At step 504, a unified execution of the complex computation may be conducted. The unified execution may be conducted using the set of processing cores. In specific embodiments, the unified execution may be unified in that there may not be master-servant relationships among the set of processing cores and each of the processing cores may execute instructions in the set of instructions to complete the complex computation.

At step 506 and during the unified execution, matrix multiplications in the set of instructions may be accelerated. The matrix multiplications may be accelerated using a set of AI accelerator cores in the set of processing cores. The set of AI accelerator cores may include dedicated circuitry to accelerate matrix multiplication operations. In specific embodiments, the dedicated circuitry may include hardware blocks to accelerate matrix multiplications. The hardware blocks may be either systolic arrays or matrix multiply accumulate units. In specific embodiments, the set of artificial intelligence accelerator cores in the set of processing cores may each include additional dedicated circuitry to accelerate at least one of the following non-linear operations: ReLU, ELU, SELU, Sigmoid, Tanh, Softplus, Swish, and GELU. In specific embodiments, the set of instructions may be from a common instruction set and the set of artificial intelligence accelerator cores may not be capable of executing a subset of the instructions in the common instruction set.

At step 508 and during the unified execution, additional instructions from the set of instructions may be executed. The additional instructions may be executed using a set of additional processing cores in the set of processing cores. The additional processing cores may not include (e.g., refrain from including) the dedicated circuitry to accelerate matrix multiplication operations. In specific embodiments, the set of processing cores may be a set of general-purpose processor cores. The set of additional processing cores may each instantiate an operating system. In specific embodiments, each general-purpose processor core in the set of general-purpose processor cores may include an operating system specified address map, a memory management unit, and a programmable logic controller. The operating system may be Linux compatible.

In specific embodiments, at step 510, a general-purpose processor core (e.g., an additional processor core) in the set of general-purpose processor cores (e.g., in the set of additional processor cores) may instantiate an Ethernet portal. The general-purpose processor core may instantiate the Ethernet portal using the operating system. In specific embodiments, step 510 may be part of step 508 (e.g., executing additional instructions). In specific embodiments, step 510 may occur before step 504 (e.g., before the complex computation is conducted), for example as part of a previous set of instructions.

In specific embodiments, at step 512, a general-purpose processor core (e.g., an additional processor core) in the set of general-purpose processor cores (e.g., in the set of additional processor cores) may access information for the complex computation. The general-purpose processor core may use the Ethernet portal to access the information. The general-purpose processor core may access the information based on the set of instructions loaded into the set of processing cores (e.g., at step 502). In specific embodiments, step 512 may be part of step 508 (e.g., executing additional instructions).

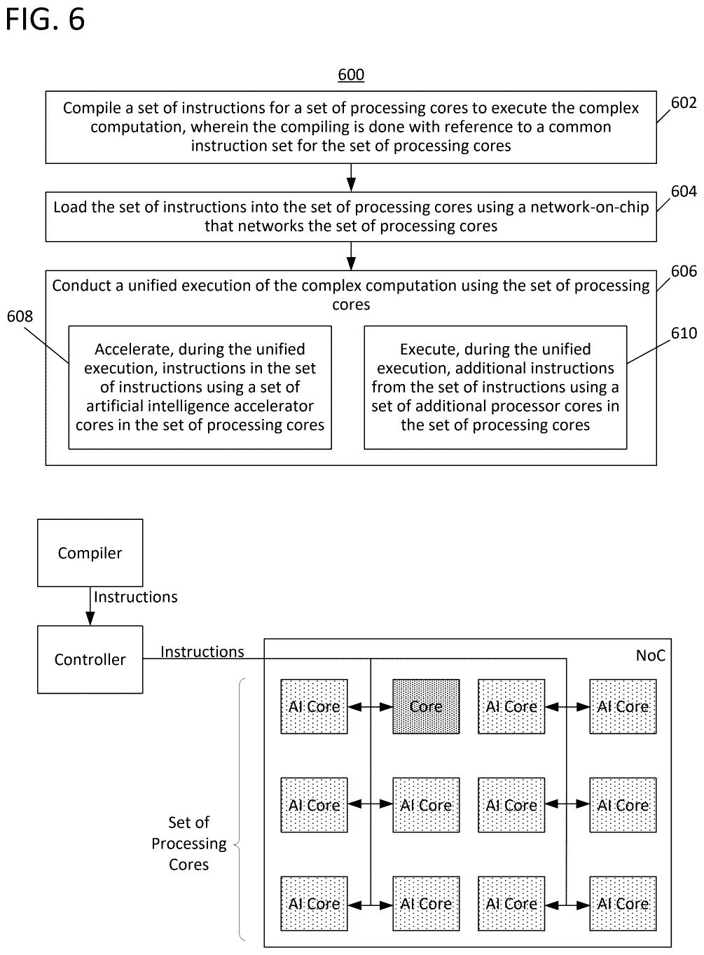

FIG. 6 shows method 600 for executing a complex computation where the set of AI accelerator cores are not capable of executing a subset of the instructions in accordance with specific embodiments of the inventions disclosed herein. Method 600 may be performed by a system including a set of processing cores, a NoC, a set of AI accelerator cores, a set of additional processing cores, and a set of instructions. In specific embodiments, the system may also include a compiler and a controller. Steps, or portions of steps, of method 600 may be omitted, duplicated, rearranged or otherwise deviate from the form shown. Some steps of method 600 may occur simultaneously while others occur sequentially.

At step 602, a set of instructions for a set of processing cores may be compiled. The set of instructions may be compiled to execute the complex computation. The compiling may be done with reference to a common instruction set for the set of processing cores.

At step 604, the set of instructions may be loaded into the set of processing cores. The set of instructions may be loaded using a NoC that networks the set of processing cores.

At step 606, a unified execution of the complex computation may be conducted. The unified execution may be conducted using the set of processing cores. In specific embodiments, the unified execution may be unified in that there may not be master-servant relationships among the set of processing cores and each of the processing cores may execute instructions in the set of instructions to complete the complex computation.

At step 608 and during the unified execution, instructions in the set of instructions may be accelerated. The instructions may be accelerated using a set of AI accelerator cores in the set of processing cores. The set of AI accelerator cores may not be capable of executing a subset of the instructions in the common instruction set.

At step 610 and during the unified execution, additional instructions from the set of instructions may be executed. The additional instructions may be executed using a set of additional processor cores in the set of processor cores.

The heterogeneous processing core architecture may reduce latency for complex computations. AI accelerator cores and additional processing cores may split a common set of instructions, each core executing instructions that it is more suited to execute. The ratio of AI accelerator cores to additional processing cores may depend on the specific system and the complex computations the system is expected to encounter. With the heterogeneous processing core architecture, AI accelerator cores may not have to wait for guidance or data from a CPU before proceeding. Instead, additional processing cores may handle instructions of the complex computation that the AI accelerator core is not equipped to handle (e.g., small computations, external data look up).

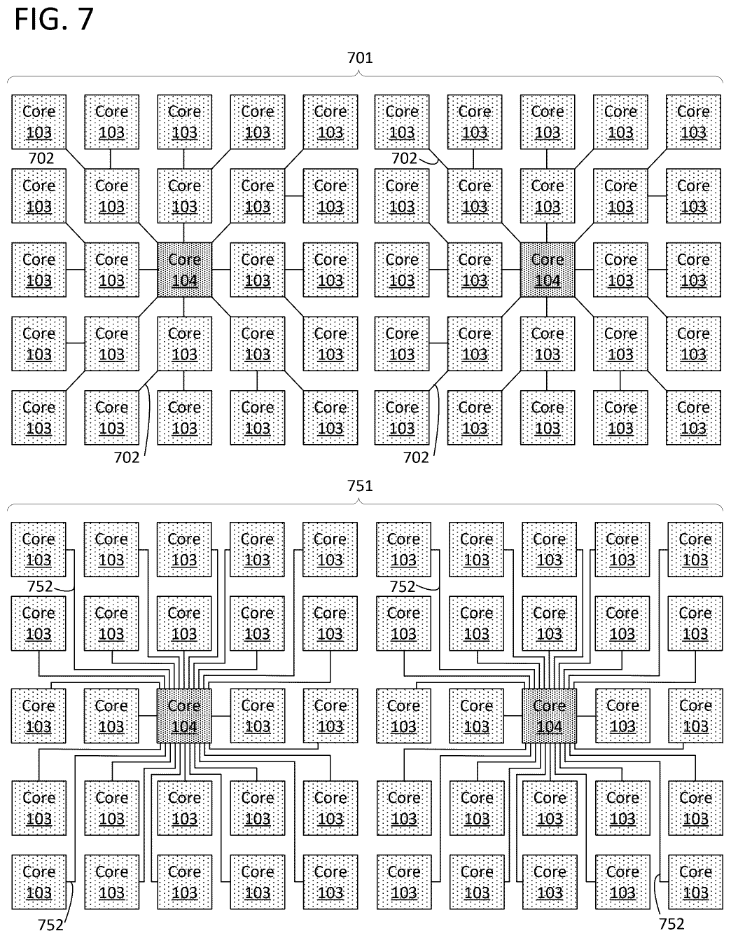

FIG. 7 shows examples of network 701 and network 751 with additional processing cores 104 interspersed among AI accelerator cores 103 such that the average physical distance from an AI accelerator core 103 to an additional processing core 104 is minimized. FIG. 7 is exemplary only as other arrangements of cores and core connections are possible, including arrangements with different ratios of additional processing cores 104 to AI accelerator cores 103. Any number of AI accelerator cores 103 and any number of additional processing cores 104 may be part of network 701 or network 751 although 48 AI accelerator cores 103 and two additional processing cores 104 are shown in each network. Connections 702 and 752 show example connections between cores. Networks 701 and 751 may be simplified such that connections 702 and 752 demonstrate how an AI accelerator core 103 may be most directly connected to a respective closest additional processing core 104 without showing extra connections between AI accelerator cores 103. In specific embodiments of the invention, the composition of the network of processing cores (ratio and arrangement of cores) may be selected based on the expected workloads that the network will operate on.

Additional processing cores 104 may be placed or interspersed among AI accelerator cores 103 such that the average physical distance from an AI accelerator core 103 to an additional processing core 104 is minimized. This may reduce communication latency, as latency may be a function of physical distance for on-die communication. Physical distance may refer to a length of connections (e.g., buses, wires) from an AI accelerator core 103 to an additional processing core 104, number of intermediate nodes between the AI accelerator core 103 to the additional processing core 104, etc. Physical distance may be measured with Euclidean distance, Manhattan distance, etc.

Additional processing cores 104 may be placed or interspersed among AI accelerator cores 103 such that the average logical distance from an AI accelerator core 103 to an additional processing core 104 is minimized. Logical distance may be measured in hops (e.g., the number of routers or switches). In specific embodiments, the distance between cores may consider (e.g., be based on) bandwidth factors, signal quality factors, and communication latency as well as other factors.

AI accelerator cores 103 may be coupled to a closest additional computational core 104 in different ways. In network 751, some AI accelerator cores 103 are connected directly to the closest additional processing core 104, while other AI accelerator cores 103 are only connected to the closest additional processing core 104 indirectly. In network 751, all AI accelerator cores 103 may be connected directly with the closest additional computational core 104.

AI accelerator cores 103 and additional processing cores 104 may split a common set of instructions, each core executing instructions that it is more suited to execute. The arrangement of additional processing cores 104 among AI accelerator cores 103 may reduce latency, as additional processing cores 104 may quickly send information (e.g., from small computations, external data look up) to AI accelerator cores 103 as part of executing the complex computation.

While the specification has been described in detail with respect to specific embodiments of the invention, it will be appreciated that those skilled in the art, upon attaining an understanding of the foregoing, may readily conceive of alterations to, variations of, and equivalents to these embodiments. While the example of a computational architecture in the form of a network of processing cores is used as an example throughout this disclosure, the approaches disclosed herein are more broadly applicable to any network of computational nodes. While the example of artificial intelligence workloads and artificial intelligence accelerators are used as an example throughout this disclosure, the approaches disclosed herein are more broadly applicable to any form of complex computation and accelerators which are configured to accelerate a majority, but not all, of the computations required for the full execution of a complex computation. These and other modifications and variations to the present invention may be practiced by those skilled in the art, without departing from the scope of the present invention, which is more particularly set forth in the appended claims.

What is claimed is:

1. A system for executing a complex computation comprising:
a set of processing cores;
a network-on-chip that networks the set of processing cores;
a set of artificial intelligence accelerator cores in the set of processing cores that each include dedicated circuitry to accelerate matrix multiplication operations;
a set of additional processing cores in the set of processing cores that do not include the dedicated circuitry to accelerate matrix multiplication operations; and
a set of instructions loaded into the set of processing cores that, when executed by both the set of artificial intelligence accelerator cores and the set of additional processing cores, cause the set of processing cores to conduct a unified execution of the complex computation.

2. The system of claim 1, wherein:
the set of additional processing cores are a set of general-purpose processor cores; and
the set of additional processing cores each instantiate an operating system.

3. The system of claim 2, wherein:
each general-purpose processor core in the set of general-purpose processor cores includes an operating system specified address map, a memory management unit, and a programmable logic controller; and
the operating system is Linux compatible.

4. The system of claim 2, wherein:
a general-purpose processor core in the set of general-purpose processor cores instantiates an Ethernet portal using the operating system; and
the set of instructions loaded into the set of processing cores include instructions for the general-purpose processor core to access information for the complex computation using the Ethernet portal.

5. The system of claim 1, wherein the unified execution is unified in that:
there are no master-servant relationships among the set of processing cores; and
each of the processing cores executes instructions in the set of instructions to complete the complex computation.

6. The system of claim 1, wherein:
the set of instructions are from a common instruction set for the system; and
the set of artificial intelligence accelerator cores are not capable of executing a subset of the instructions in the common instruction set.

7. The system of claim 1, wherein:
the dedicated circuitry includes hardware blocks to accelerate matrix multiplications; and
the hardware blocks are one of systolic arrays and matrix multiply accumulate units.

8. The system of claim 1, wherein:
the set of artificial intelligence accelerator cores in the set of processing cores each include additional dedicated circuitry to accelerate at least one of the following non-linear operations: ReLU, ELU, SELU, Sigmoid, Tanh, Softplus, Swish, and GELU.

9. The system of claim 1, wherein:
the network-on-chip uses an extensible addressing scheme; and
the set of instructions uses the extensible addressing scheme.

10. The system of claim 1, further comprising:
a compiler that generates the set of instructions for the system; and
a controller that loads the set of instructions into the set of processing cores using the network-on-chip.

11. The system of claim 1, wherein:
the artificial intelligence accelerator cores and the additional processing cores in the set of processing cores are in an at least twenty five to one ratio.

12. The system of claim 1, wherein:
the set of additional processing cores is interspersed within the set of artificial intelligence accelerator cores such that an average physical distance from each artificial intelligence accelerator core of the set of artificial intelligence accelerator cores and a corresponding nearest additional processing core in the set of additional processing cores is minimized.

13. The system of claim 1, wherein:
the set of additional processing cores is interspersed within the set of artificial intelligence accelerator cores to minimize an average latency of messages between an artificial intelligence accelerator core of the set of artificial intelligence accelerator cores and a corresponding nearest additional processing cores in the set of additional processing cores.

14. A method for executing a complex computation comprising:
loading a set of instructions into a set of processing cores using a network-on-chip that networks the set of processing cores;
conducting a unified execution of the complex computation using the set of processing cores;
accelerating, during the unified execution, matrix multiplications in the set of instructions using a set of artificial intelligence accelerator cores in the set of processing cores, wherein the set of artificial intelligence accelerator cores include dedicated circuitry to accelerate matrix multiplication operations; and
executing, during the unified execution, additional instructions from the set of instructions using a set of additional processing cores in the set of processing cores, wherein the additional processing cores do not include the dedicated circuitry to accelerate matrix multiplication operations.

15. The method of claim 14, wherein:
the set of additional processing cores are a set of general-purpose processor cores; and
the set of additional processing cores each instantiate an operating system.

16. The method of claim 15, wherein:
each general-purpose processor core in the set of general-purpose processor cores includes an operating system specified address map, a memory management unit, and a programmable logic controller; and
the operating system is Linux compatible.

17. The method of claim 15, further comprising:
instantiating, by a general-purpose processor core in the set of general-purpose processor cores, an Ethernet portal using the operating system; and
accessing, by the general-purpose processor core and using the Ethernet portal, information for the complex computation based at least in part on the set of instructions loaded into the set of processing cores.

18. The method of claim 14, wherein the unified execution is unified in that:
there are no master-servant relationships among the set of processing cores; and
each of the processing cores executes instructions in the set of instructions to complete the complex computation.

19. The method of claim 14, wherein:
the set of instructions are from a common instruction set; and
the set of artificial intelligence accelerator cores are not capable of executing a subset of the instructions in the common instruction set.

20. The method of claim 14, wherein:
the dedicated circuitry includes hardware blocks to accelerate matrix multiplications; and
the hardware blocks are one of: systolic arrays and matrix multiply accumulate units.

21. The method of claim 14, wherein:
the set of artificial intelligence accelerator cores in the set of processing cores each include additional dedicated circuitry to accelerate at least one of the following non-linear operations: ReLU, ELU, SELU, Sigmoid, Tanh, Softplus, Swish, and GELU.

22. The method of claim 14, wherein:
the set of additional processing cores is interspersed within the set of artificial intelligence accelerator cores such that an average physical distance from each artificial intelligence accelerator core of the set of artificial intelligence accelerator cores and a corresponding nearest additional processing core in the set of additional processing cores is minimized.

23. A method for executing a complex computation comprising:
compiling a set of instructions for a set of processing cores to execute the complex computation, wherein the compiling is done with reference to a common instruction set for the set of processing cores;
loading the set of instructions into the set of processing cores using a network-on-chip that networks the set of processing cores;
conducting a unified execution of the complex computation using the set of processing cores;
accelerating, during the unified execution, instructions in the set of instructions using a set of artificial intelligence accelerator cores in the set of processing cores, wherein the set of artificial intelligence accelerator cores are not capable of executing a subset of the instructions in the common instruction set; and
executing, during the unified execution, additional instructions from the set of instructions using a set of additional processor cores in the set of processing cores.
